(19) United States
(12) Patent Application Publication
(10) Pub. No.: US 2014/0249798 A1
(43) Pub. Date: Sep. 4, 2014

(54) TRANSLATION SYSTEM AND TRANSLATION METHOD THEREOF

(71) Applicant: FOXLINK IMAGE TECHNOLOGY CO., LTD., New Taipei City (TW)

(72) Inventors: Chun Yuan Sun, New Taipei City (TW); Chi Wen Chen, New Taipei City (TW)

(73) Assignee: Foxlink Image Technology Co., Ltd., New Taipei City (TW)

(21) Appl. No.: 13/783,546

(22) Filed: Mar. 4, 2013

(51) Int. Cl. G06F 17/28

(52) U.S. Cl. CPC G06F 17/28
USPC 704/3

(57) ABSTRACT

A translation system is connected with at least two translation service providers through internet and includes an image capture unit, a data transmission unit, a comparing unit, and a display unit. A translation method is achieved by the foregoing translation system and includes the steps: capturing original data of original documents as an image data by means of the image capture unit; transmitting the image data to an image recognition unit and utilizing the image recognition unit to convert the image data into text data; transmitting the text data to the translation service providers for translation; utilizing the comparing unit to compare translation results and determine one of them as the best translation result according to the occurrence number of the same words in the compared translation results; and displaying the best translation result on a display unit. So the user can review the translation results quickly and easily.

### BACKGROUND OF THE INVENTION

1. Field of the Invention

The present invention relates to a machine translation system, especially to a translation system that works with translation server and a translation method thereof.

2. The Related Art

The exchange of information around the world have become more and more frequent in the trend of internationalization. As a result, people contact with documents written in foreign languages more and more often. For some people who are less skilled in foreign languages, it might take them lots of time to translate the document before reading it.

In order to speed up the translation process, there have been a plurality of portable devices available for users to use. For example, an ordinary scanning translation pen can scan a single word in the document and translate it by means of the built-in optical character recognition (OCR) module and the dictionary database. However, it only provides verbatim translation so it is not fast enough for a large document. Another kind of translation device is the smart phone that becomes more and more popular these days. The smart phone can take the image of the original document with its camera module for OCR, and translate it by means of a build-in dictionary module or by a translation sever on the internet.

With said scanning or photographing means, the images of original documents can be captured quickly and easily, so the users can save a lot of time to input the content into a translation device. However, the accuracy of machine translation is not good enough in practice, so the users need to spend long time to review the translation result.

On the other hand, many Internet service providers have started to provide online translation services, they can not only do the full-text translate, but also automatically identify that in which kind of language the document is written. The problem is that the users have to manually input the contents intended for being translated. Therefore, when a user is not familiar to the languages which the document is written in, it will take him lots of time to input. And the accuracy of full-text translation is still not good enough, and users still have to spend lots of time to review the translation result.

In view of these disadvantages above, the present translation apparatus is necessary to be improved.

### SUMMARY OF THE INVENTION

An objective of the present invention is to provide a translation system and a translation method of the translation system that help user to save time on manually inputting the content for translation and reviewing the translation result.

To meet this purpose, the translation system is connected with at least two translation service providers through internet, including: an image capture unit for capturing the original data of original documents; a data transmission unit for transmitting the original data to the translation service providers and further receiving translation results from the translation service providers; a comparing unit for comparing translation results generated by the translation service providers and then determining one of them as the best translation result according to the occurrence number of the same words in the compared translation results; and a display unit for displaying the best translation result determined by the comparing unit thereon.

The translation method of the foregoing translation system includes the steps: capturing original data of original documents as an image data by means of an image capture unit; transmitting the image data of the original documents to an image recognition unit and utilizing the image recognition unit to convert the image data into text data; transmitting the text data to a plurality of translation service providers for translation; then utilizing a comparing unit to compare translation results generated by the translation service providers, and then determine one of them as the best translation result according to the occurrence number of the same words in the compared translation results; and displaying the best translation result on a display unit.

The translation method in this invention is characterized by that the translation system captures the original data of the original document as the image data by scanning or photographing and then the image recognition unit utilizes the optical character recognition (OCR) technology to convert the image data into the text data automatically. The converted text data is uploaded to a plurality of translation service providers through the internet for translation. It saves users lots of time to input the content for being translated. Furthermore, the translation results generated by the translation service providers can be compared with one another by the comparing unit to determine one of them as the best translation result, so it further saves users lots of time to review the translation result.

### BRIEF DESCRIPTION OF THE DRAWINGS

The present invention will be apparent to those skilled in the art by reading the following description, with reference to the attached drawings, in which:

FIG. 1 shows a block diagram of a translation system according to one embodiment of the present invention;

FIG. 2 shows the process of capturing original data of original documents as an image data;

FIG. 3 shows a block diagram of the translation system according to another embodiment of the present invention;

FIG. 4 shows a flowchart of a translation method of using the translation system to translate the original document in accordance with the present invention;

FIG. 5 is a schematic diagram of segmenting each of translation results into many sentences; and

FIG. 6 shows the interface of a display unit of the translation system for displaying the translation results.

### DETAILED DESCRIPTION OF THE PREFERRED EMBODIMENT

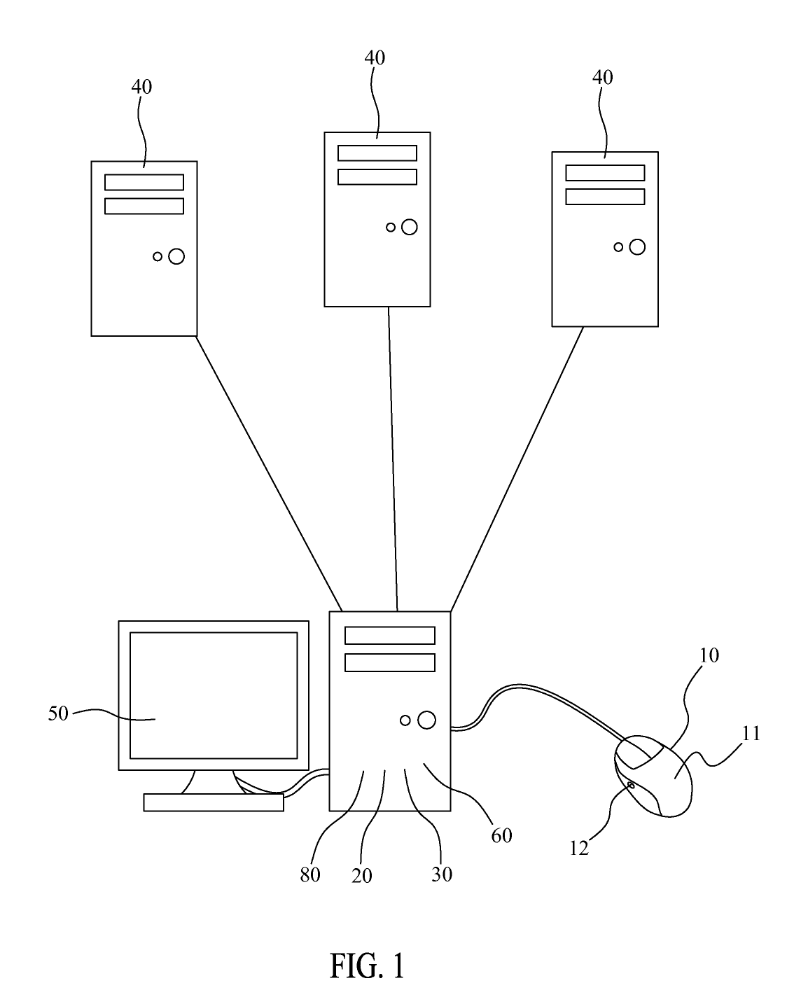

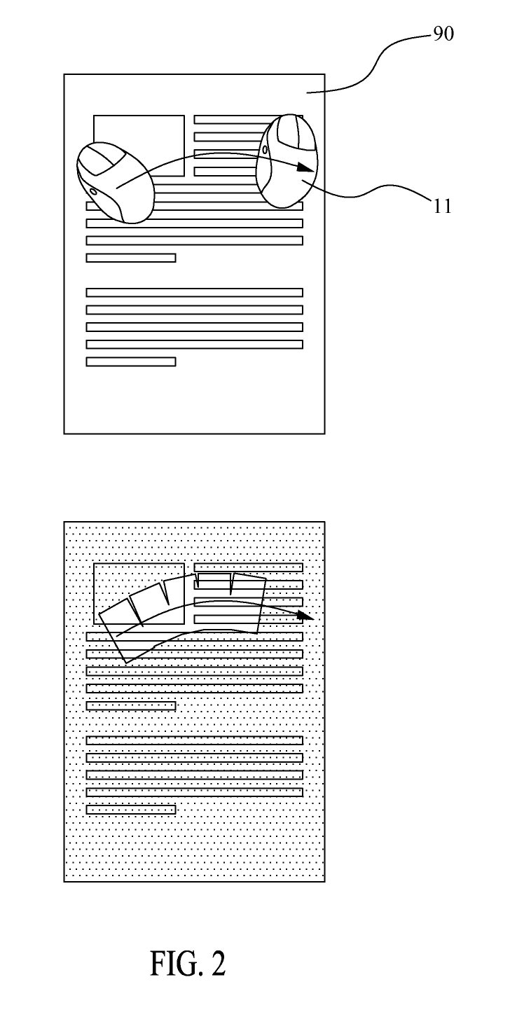

Referring to FIG. 1 and FIG. 2, a translation system in accordance with one embodiment of the present invention is shown for translating an original document 90. The translation system connects with a plurality of translation service providers 40 through internet and includes an image capture unit 10, an image stitching unit 60, an image recognition unit 20, a data transmission unit 30, a comparing unit 80 and a display unit 50.

In this embodiment, the image capture unit 10 is a mouse 11 having scanning function, namely image capture function. The mouse 11 is equipped with a CIS (Contact Image Sensor, not shown) and an activating switch 12 placed at one lateral of the mouse 11. When the user presses the activating switch 12, the CIS will begin to capture images periodically. Then the user moves the mouse 11 through the surface of the original document 90 to get the original data of the original document 90 as many images piece by piece.

The images captured by the mouse 11 are transmitted to the image stitching unit 60 for being stitched into a complete image data. Then the complete image data is transmitted to the image recognition unit 20 to be converted into text data by the image recognition unit 20 utilizing Optical Character Recognition technology. In this embodiment, the image stitching unit 60 and the image recognition unit 20 are provided within a PC (personal computer), and the mouse 11 is connected with the personal computer via a wired or wireless means for transmitting the image data.

After the complete image data is converted into the text data, the text data will be transmitted to the translation service providers 40 through the internet with the data transmission unit 30 that is built in the PC. The translation service provider 40 will identify which kind of language the original document is written in and then translate it. The translation results generated by the translation service providers 40 will be transmitted back to the PC through the internet for being compared by the comparing unit 80, and the comparing unit 80 further determines one of them as the best translation result according to the occurrence number of the same words in the compared translation results. Then all of the translation results and the best translation result are showed on the display unit 50, namely the monitor screen of the PC.

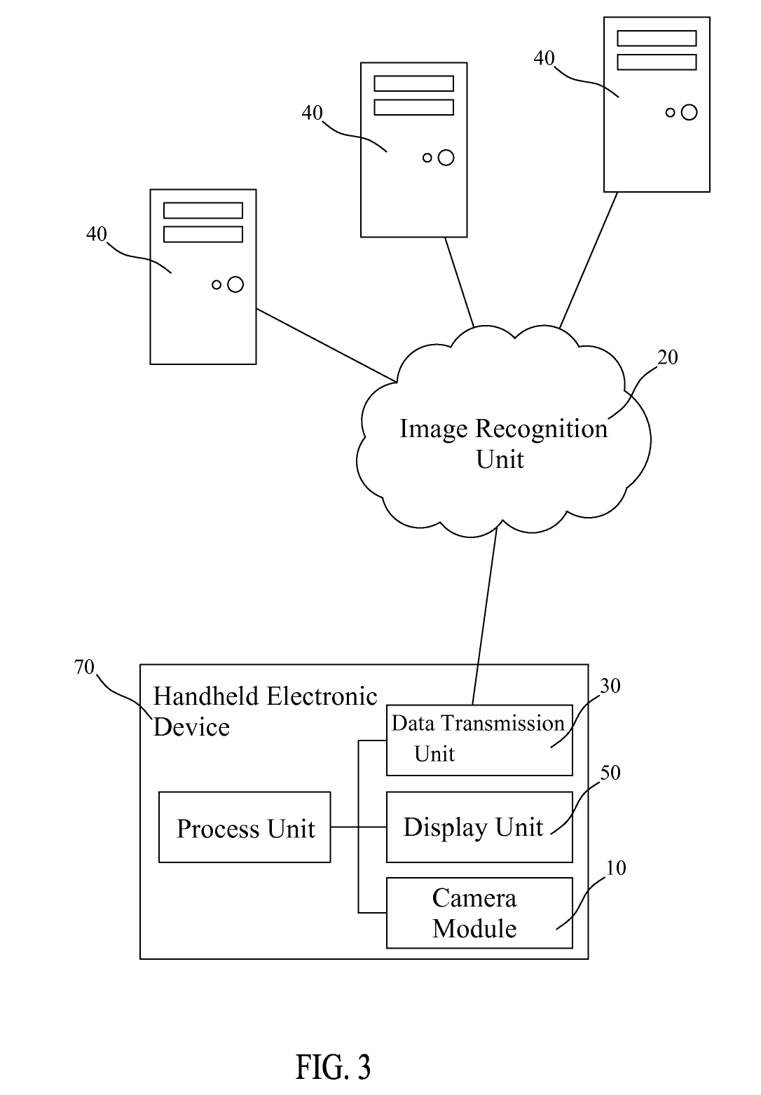

It is noticed that the image capture unit 10 in this invention should not be limited to a mouse or a scanner, and the image recognition unit 20 is not limited to be built in the user-side device such as the PC. As shown in FIG. 3, it shows another embodiment of the translation system according to the present invention. In this embodiment, the image capture unit 10 is a camera module installed in a handheld electronic device 70. The Optical Character Recognition function is not available on the handheld electronic device 70 due to the limit of lack of computing power, so the image data will be transmitted to an external server with the image recognition unit 20 therein through the data transmission unit 30 built inside the handheld electronic device 70 so as to be converted into the text data. Then the text data will be sent to the translation service providers 40 for translation.

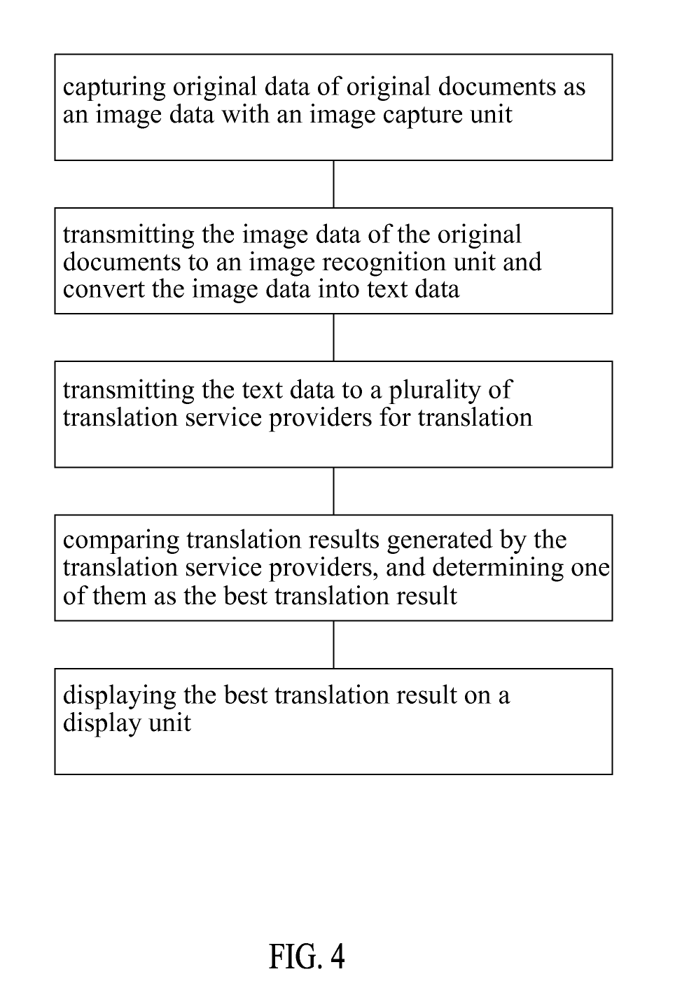

Referring to FIGS. 1-4, a translation method using the foregoing translation system to translate the original document 90 in this invention is described below.

First, utilize the image capture unit 10 to capture the original data of the original documents 90 as the image data. Then transmit the image data to the image recognition unit 20 and utilize the image recognition unit 20 to convert the image data into the text data. Next, transmit the text data to all of the translation service providers 40, each of the translation service providers 40 has unique translation database so the translation results generated by each translation service provider 40 might be different. After all of the translation results are received, utilizing the comparing unit 80 to compare the translation results and then determine one of them as the best translation result according to the occurrence number of the same words in the compared translation results. And at last, the original data of the original documents 90, all of the translation results and the best translation results will be shown together on the display unit 50 for users to review. In this way, the user can translate a document into a familiar language quickly and review it easily.

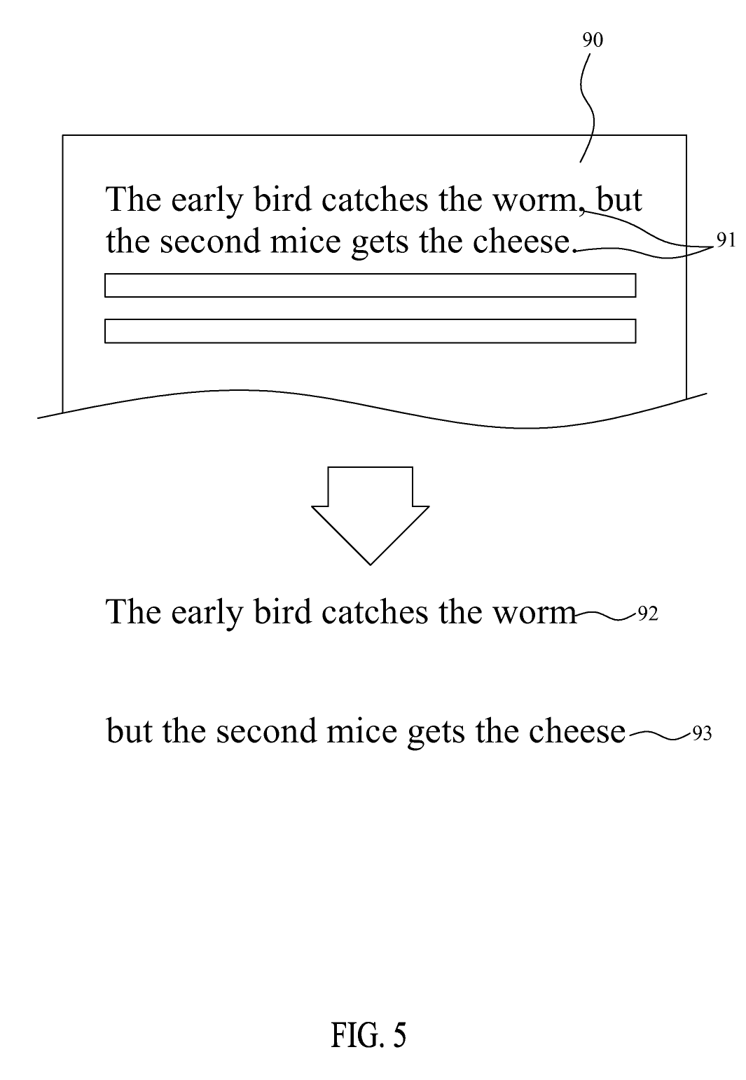

Referring to FIG. 5, in the foregoing translation method, the process of utilizing the comparing unit 80 to compare the translation results includes the steps: segmenting each of the translation results from different translation service providers 40 into many sentences by punctuation 91 and further numbering the sentences of each translation result in proper sequence. For example, in this embodiment, the translation result is separated into two sentences: a first sentence 92 and a second sentence 93. After that, the sentences numbered in the same number in all of the translation results will be compared with one another to count the occurrence number of the same words in the compared sentences of the translation results. At last, the translation result with the highest occurrence number of the same words will be determined as the best translation result.

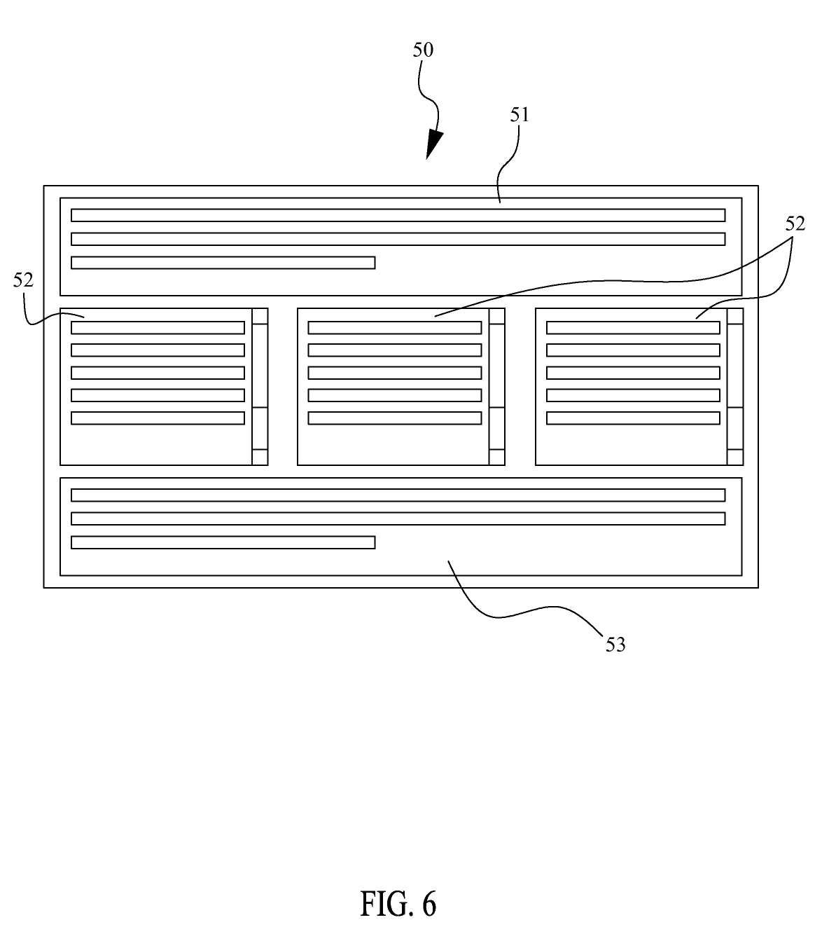

Referring to FIG. 6, the original data, all of the translation results and the best translation result are displayed on the display unit 50 in a manner, it is that all of the translation results are abreast on the middle 52 of the display unit 50, the original data of the original documents 90 is on the top region 51 of the display unit 50 and the best translation result is on the bottom region 53 of the display unit 50. Therefore, users can review all of the translation results at once.

In summary, the translation system and the translation method thereof in this invention can capture the original data of the original document 90 as the image data by scanning or photographing and convert the image data into the text data automatically. The converted text data is uploaded to a plurality of translation service providers 40 through internet for translation. It will save users lots of time to input the content for being translated. Furthermore, the translation results can be compared with one another to determine one of them as the best translation result which will be displayed on the display unit 50 for user to review. The original data of the original documents 90 and all of the translation results are also displayed on the display unit 50 at the same time, so the user can review all of them at once.

What is claimed is:

1. A translation system, connected with at least two translation service providers through the internet, comprising:
an image capture unit for capturing original data of original documents;
a data transmission unit for transmitting the original data to the translation service providers and further receiving translation results from the translation service providers;
a comparing unit for comparing the translation results generated by the translation service providers and then determining one of them as the best translation result according to the occurrence number of the same words in the compared translation results; and
a display unit for displaying the best translation result determined by the comparing unit thereon.

2. The translation system as claimed in claim 1, wherein the display unit is capable of further displaying the original data of the original documents and all of the translation results generated by the translation service providers thereon.

3. The translation system as claimed in claim 1, further comprising an image stitching unit, the original data captured by the image capture unit is shown as many images, the image stitching unit is used for stitching the images to generate a complete image data.

4. The translation system as claimed in claim 3, further comprising an image recognition unit located on the internet for receiving the image data and then converting the image data into text data which is transmitted to and translated by the translation service providers.

5. The translation system as claimed in claim 3, further comprising an image recognition unit located in a personal computing device at the user-side for receiving and converting the image data into text data which is transmitted to and translated by the translation service providers.

6. The translation system as claimed in claim 1, wherein the image capture unit is a device chosen from a scanner, a camera and a mouse having an image capture function.

7. A translation method of the foregoing translation system, comprising the steps:
capturing original data of original documents as an image data by means of an image capture unit;
transmitting the image data of the original documents to an image recognition unit and utilizing the image recognition unit to convert the image data into text data;
transmitting the text data to a plurality of translation service providers for translation;
utilizing a comparing unit to compare translation results generated by the translation service providers, and then determine one of them as the best translation result according to the occurrence number of the same words in the compared translation results; and
displaying the best translation result on a display unit.

8. The method as claimed in claim 7, wherein the display unit is capable of further displaying the original data of the original documents and all of the translation results thereon.

9. The method as claimed in claim 8, wherein the original data of the original documents, all of the translation results and the best translation result are displayed on the display unit in a manner, it is that all of the translation results are abreast on the middle region of the display unit, the original data of the original documents is on the top region of the display unit and the best translation result is on the bottom region of the display unit.

10. The method as claimed in claim 7, wherein the process of utilizing the comparing unit to compare the translation results includes the steps:
segmenting each of the translation results from different translation service providers into many sentences by punctuation, and further numbering the sentences of each translation result in proper sequence;
comparing the sentences numbered in the same number in all of the translation results, and counting the occurrence number of the same words in the compared sentences of the translation results; and
determining the translation result with the highest occurrence number of the same words as the best translation result.
